(19) United States
(12) Patent Application Publication
(10) Pub. No.: US 2025/0111638 A1
(43) Pub. Date: Apr. 3, 2025

(54) IMAGING PRIVACY FILTER FOR OBJECTS OF INTEREST IN HARDWARE FIRMWARE PLATFORM

(71) Applicant: ATI Technologies ULC, Markham (CA)

(72) Inventors: William Lloyd Atkinson, Markham (CA); Wilson Hung Yu, Markham (CA)

(73) Assignee: ATI Technologies ULC, Markham (CA)

(21) Appl. No.: 18/477,389

(22) Filed: Sep. 28, 2023

(51) Int. Cl. G06V 10/25; G06T 5/00; G06T 11/60

(52) U.S. Cl. CPC G06V 10/25; G06T 5/70; G06T 11/60; G06T 2207/20084; G06T 2207/20132; G06V 2201/07

(57) ABSTRACT

A method and computing device is provided for filtering objects of interest of images. The computing device comprises an image capturing device and memory configured to store objects of interest. In one example, the computing device comprises a processor configured to, for a captured image, determine one or more regions of interest in the image based on the objects of interest and modify the image based on the determined regions of interest. In another example, the computing device comprises a first processor configured to determine one or more regions of interest to be modified in an image based on the one or more objects of interest and a second processor configured to convert the image to be processed by the first processor and modify the image based on regions of interest determined by the first processor. The image is displayed without the one or more objects of interest being viewable.

### BACKGROUND

Most computing devices (e.g., laptops, personal computers, smart phones and tablets) include an image capturing device (e.g., a camera) to capture images. The captured images can then be displayed, for example, on a display of the computing device. For example, the images captured at the computing device are displayed, during video conferencing, on the display devices of multiple computing devices connected via a network.

### BRIEF DESCRIPTION OF THE DRAWINGS

A more detailed understanding can be had from the following description, given by way of example in conjunction with the accompanying drawings wherein:

FIG. 1 is a block diagram of an example computing device in which one or more features of the disclosure can be implemented;

FIG. 2 is a block diagram of the device, illustrating additional details related to execution of processing tasks on an accelerated processing device, according to an example;

FIG. 3 is a block diagram illustrating components of a computing device in which one or more features of the disclosure can be implemented, according to an example;

FIG. 4 is a block diagram illustrating components of a computing device in which one or more features of the disclosure can be implemented, according to an example;

FIG. 5 is a block diagram illustrating components of a computing device in which one or more features of the disclosure can be implemented, according to another example;

FIG. 6 is a block diagram illustrating components of a computing device in which one or more features of the disclosure can be implemented, according to another example; and

FIG. 7 is a flow diagram illustrating an example method of filtering objects of interest for video conferencing according to features of the disclosure.

### DETAILED DESCRIPTION

Privacy is a major concern for any use case in which images captured at a computing device, are to be displayed and viewed by others (e.g., images captured and displayed during video conferencing). Video conferencing can be used for various environments, such as a work environment (employers, employees, clients), a school environment (e.g., students and teachers) or a personal environment (e.g., family and friends). In some cases, users of computing devices may not wish for certain objects to be viewed by others during video conferencing.

For example, during video conferencing, family members may unexpectedly come into a field of view of the camera of the computing device. During video conferencing in a work environment, a user of a computing device may not wish for certain objects, such as faces of their family or other objects in the field of view, to be viewable by others on their displays. However, conventional computing devices are not able to reliably prevent particular objects of interest, such as faces of family members, from being viewed (i.e., viewed clearly such that the faces are identifiable) by other people participating in a video conference.

For simplification purposes, examples of the present disclosure described herein include computing devices and methods for filtering objects of interest of images displayed during video conferencing. However, features of the present disclosure can be implemented for adding security and privacy for any use case in which images captured at a computing device are to be displayed and viewed by others.

Features of the present disclosure include a stored object of interest list (e.g., nonviewable objects of interest, such as faces of individuals which are not to be viewed by others and/or viewable objects of interest, such as faces of individuals permitted to be viewed by others). Object of interest information (e.g., corresponding to the objects of interest in the object of interest list) is provided to object detection hardware (e.g., a neural network processor, such as an inference processing unit (IPU) or an image signal processor (ISP)). The object detection hardware determines whether regions of the images, captured by the image capturing device (e.g., a camera) of the computing device, include one or more objects of interest in the object of interest list.

For example, the object of interest information is provided to the IPU determines whether any regions of the images (processed by the ISP and provided to the IPU) include one or more objects of interest in the object of interest list. The IPU then provides region of interest information to the ISP which modifies (or maintains) the images based on the region of interest information. Alternatively, the ISP is also configured to perform object detection (e.g., face detection) and the object of interest information is provided to the ISP to perform the object detection.

The captured frames are monitored and modified (e.g., by a processor of the computing device) to prevent one or more nonviewable objects of interest from being viewed during video conferencing. When a nonviewable object of interest is detected (e.g., by a processor of the device) in an image (or frame), the image is modified to prevent the nonviewable object of interest from being viewed. For example, a nonviewable object of interest is prevented from being viewed by removing, blurring (or otherwise preventing the object from being viewed clearly) the nonviewable object of interest from the image (e.g., block list behavior). Additionally, or alternatively, a nonviewable object of interest is prevented from being viewed by focusing on another object of interest, such as a viewable object of interest from a list of viewable objects of interest (e.g., allow list behavior). For example, an image can be cropped such that one or more predetermined viewable objects of interest (e.g., a face of a user or face of another person, such as another employee, permitted to be viewed) is shown in the image and one or more nonviewable objects of interest (e.g., faces of family members) are prevented from being viewed.

The devices and methods described herein facilitate additional security because the nonviewable object of interest in the images are detected via secure hardware and firmware (i.e., separate from the OS level). That is, instead of modifying the images after they are provided to the OS software, the images are processed by hardware (HW) and firmware (FW) components of the computing device in a secure domain (i.e., separate from the OS) which prevents the images from being hacked from outside sources.

In addition, both the images provided from the ISP to the IPU and the region of interest information provided from the IPU to the ISP are performed quickly and with reduced power consumption because they are both exchanged without using a central processing unit (CPU) or a graphics processing unit (GPU) of the device.

A method of filtering objects of interest of images captured at a computing device is provided which comprises, for a captured image, determining one or more regions of interest in the captured image based on one or more objects of interest and modifying the captured image for display based on the determined one or more regions of interest. The captured image is displayed without the one or more objects of interest being viewable.

A computing device for filtering objects of interest of images is provided which comprises an image capturing device, memory configured to store objects of interest; and a processor configured to, for an image captured by the image capturing device, determine one or more regions of interest in the image based on one or more objects of interest and modify the image based on the determined one or more regions of interest. The image is displayed without the one or more objects of interest being viewable.

A computing device for filtering objects of interest of images is provided which comprises an image capturing device; memory configured to store objects of interest; and a first processor configured to, for an image captured by the image capturing device, determine one or more regions of interest to be modified in an image captured by the image capturing device based on the one or more selected objects of interest. The computing device also comprises a second processor configured to, for the image captured by the image capturing device, convert the image for processing by the first processor and modify the image based on the one or more regions of interest determined by the first processor. The image is displayed without the one or more objects of interest being viewable.

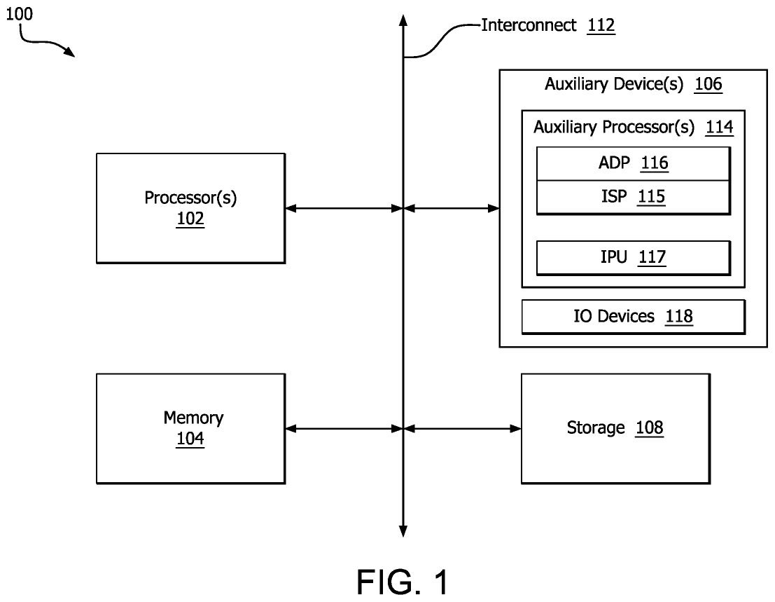

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106 and storage 108. An interconnect 112, which can be a bus, a combination of buses, and/or any other communication component, communicatively links the processor(s) 102, the memory 104, the auxiliary device(s) 106 and the storage 108.

In various alternatives, the processor(s) 102 include a CPU, a GPU, a CPU and GPU located on the same die, or one or more processor cores, wherein each processor core can be a CPU, a GPU, or a neural processor. In various alternatives, at least part of the memory 104 is located on the same die as one or more of the processor(s) 102, such as on the same chip or in an interposer arrangement, and/or at least part of the memory 104 is located separately from the processor(s) 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The auxiliary device(s) 106 include, without limitation, one or more auxiliary processors 114, and/or one or more input/output (“IO”) devices. The auxiliary processor(s) 114 include, without limitation, a processing unit capable of executing instructions, such as a CPU, a GPU, a parallel processing unit capable of performing compute shader operations in a single-instruction-multiple-data form, multimedia accelerators such as video encoding or decoding accelerators, or any other processor.

For example, as shown in FIG. 1, auxiliary processor(s) 114 include an accelerated processing device (“APD”) 116, an image signal processor (ISP) 115 and an inference processing unit (IPU) 117. As described in more detail herein, in various alternatives, features of the disclosure can be implemented using one or more of these auxiliary processors 114 shown in FIG. 1.

Any auxiliary processor 114 is implementable as a programmable processor that executes instructions, a fixed function processor that processes data according to fixed hardware circuitry, a combination thereof, or any other type of processor. In addition, although processor(s) 102 and APD 116 are shown separately in FIG. 1, in some examples, processor(s) 102 and APD 116 may be on the same chip.

The one or more IO devices 118 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display, a speaker, a printer, a haptic feedback device, one or more lights, an antenna, or a network connection (e.g., a wireless local area network card for transmission and/or reception of wireless IEEE 802 signals).

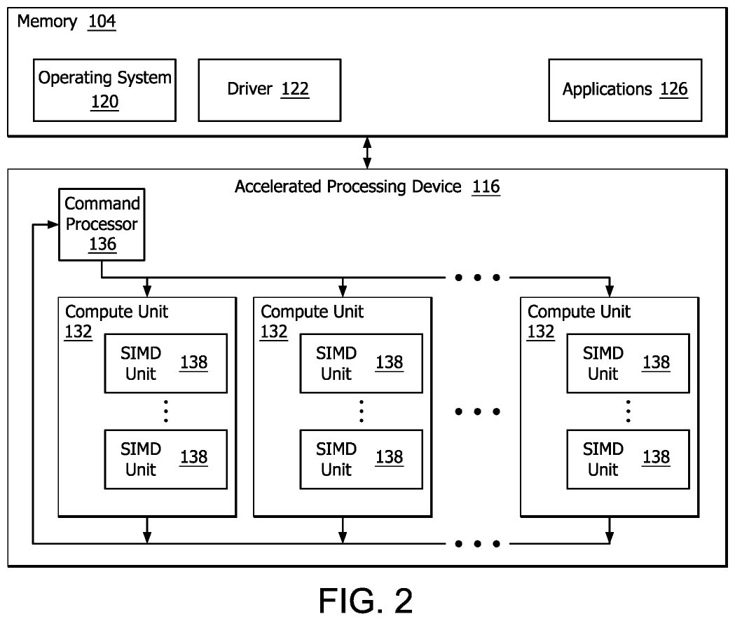

FIG. 2 is a block diagram of the device, illustrating additional details related to execution of processing tasks on the APD 116, according to an example. The processor 102 maintains, in system memory 104, one or more control logic modules for execution by the processor(s) 102. The control logic modules include an operating system 120, a driver 122, and applications 126, and may optionally include other modules not shown. These control logic modules control various aspects of the operation of the processor(s) 102 and the APD 116. For example, the operating system 120 directly communicates with hardware and provides an interface to the hardware for other software executing on the processor(s) 102. The driver 122 controls operation of the APD 116 by, for example, providing an application programming interface (“API”) to software (e.g., applications 126) executing on the processor(s) 102 to access various functionality of the APD 116. The driver 122 also includes a just-in-time compiler that compiles shader code into shader programs for execution by processing components (such as the SIMD units 138 discussed in further detail below) of the APD 116.

The APD 116 executes commands and programs for selected functions, such as graphics operations and non-graphics operations, which may be suited for parallel processing. The APD 116 can be used for executing graphics pipeline operations such as pixel operations, geometric computations, and rendering an image to a display device (e.g., one of the IO devices 118) based on commands received from the processor(s) 102. The APD 116 also executes compute processing operations that are not directly related to graphics operations, such as operations related to video or other tasks, based on commands received from the processor 102 or that are not part of the “normal” information flow of a graphics processing pipeline, or that are completely unrelated to graphics operations (sometimes referred to as “GPGPU” or “general purpose graphics processing unit”).

The APD 116 includes compute units 132 (which may collectively be referred to herein as “programmable processing units”) that include one or more SIMD units 138 that are configured to perform operations in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by individual lanes, predication of lanes corresponding to control flow paths not currently being executed, and serial execution of different control flow paths, allows for arbitrary control flow to be followed.

The basic unit of execution in compute units 132 is a work-item. Each work-item represents a single instantiation of a shader program that is to be executed in parallel in a particular lane of a wavefront. Work-items can be executed simultaneously as a “wavefront” on a single SIMD unit 138. Multiple wavefronts may be included in a “work group,” which includes a collection of work-items designated to execute the same program. A work group can be executed by executing each of the wavefronts that make up the work group. The wavefronts may be executed sequentially on a single SIMD unit 138 or partially or fully in parallel on different SIMD units 138. Wavefronts can be thought of as instances of parallel execution of a shader program, where each wavefront includes multiple work-items that execute simultaneously on a single SIMD unit 138 in line with the SIMD paradigm (e.g., one instruction control unit executing the same stream of instructions with multiple data). A command processor 136, which may include a scheduler (not shown), is present in the compute units 132 and is configured to launch wavefronts based on work (e.g., execution tasks) that is waiting to be completed and perform operations related to scheduling various wavefronts on different compute units 132 and SIMD units 138.

The parallelism afforded by the compute units 132 is suitable for graphics related operations such as pixel value calculations, vertex transformations, tessellation, geometry shading operations, and other graphics operations. A graphics processing pipeline, which accepts graphics processing commands from the processor(s) 102, thus provides computation tasks to the compute units 132 for execution in parallel.

The compute units 132 are also used to perform computation tasks not related to graphics or not performed as part of the “normal” operation of a graphics processing pipeline (e.g., custom operations performed to supplement processing performed for operation of the graphics processing pipeline). An application 126 or other software executing on the processor(s) 102 transmits programs (often referred to as “compute shader programs,” which may be compiled by the driver 122) that define such computation tasks to the APD 116 for execution.

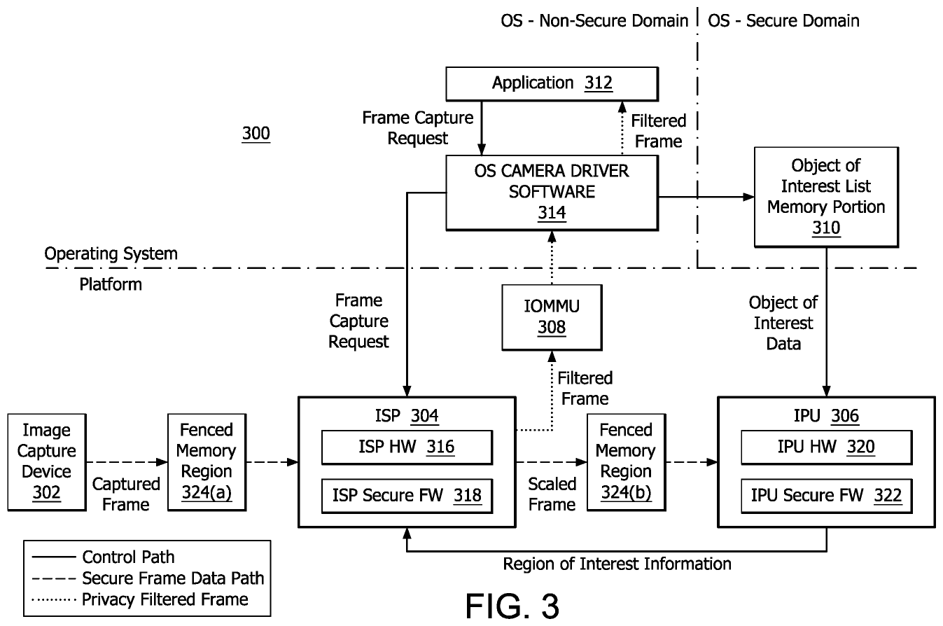

As described in more detail below with regard to FIG. 3, an ISP 304 acts as a sub-device of the APD 116 (e.g., GPU) in that it shares PCIe infrastructure, memory access (addressing) infrastructure and some other hardware of the APD 116, but the APD 116 and the ISP 115 are separate processors in operation and functionality.

FIG. 3 is a block diagram illustrating example components of a computing device 300 in which one or more features of the disclosure can be implemented according an example. As shown in FIG. 3, computing device 300 includes an image capture device (e.g., a camera) 302, ISP 304, inference processing unit (IPU) 306, input-output memory management unit (IOMMU) 308 and an object of interest portion of memory 310.

The ISP 304 includes ISP HW circuitry 316 and ISP secure FW 318 (e.g., in a secure domain separate from the OS) which prevents the images (frames) from being hacked from outside sources. The ISP 304 is configured to receive the captured images (e.g., mobile industry processor interface (MIPI) frames) and process the image (e.g., convert sensed raw image data (or frame data) to the RGB domain or YUV domain) to be provided to the IPU 306.

The ISP 304 is also configured to receive region of interest information from the IPU 306 and filter the image based on the region of interest information. For example, when the image includes one or more nonviewable objects of interest (e.g., indicated by the region of interest information), the ISP 304 is configured to modify (e.g., remove, obscure or blur the one or more nonviewable objects of interest) the image (i.e. the frame) and provide the privacy filtered image (or frame) to the OS via IOMMIU 308. When the image does not include one or more nonviewable objects of interest (e.g., does not include any region of interest information), the ISP 304 is configured to maintain the image (i.e., not modify the image).

The object of interest portion of memory 310 is configured to store a plurality of objects of interest (e.g., images data of faces of a user and faces of family members of a user). The stored objects of interest can be acquired from images captured during a previous video conference or from images which are not captured during a video conference (e.g., previously acquired images that are downloaded to the object of interest portion of memory 310).

As shown in FIG. 3, the object of interest list 310 is stored in a secure portion of memory (e.g., a secured, trusted portion of memory). That is, the object of interest list 310 is stored in a portion of memory which is not assessable to an unsecure (or untrusted) OS to prevent the image data from being hacked from outside sources. An unsecure OS can include, for example, an unsecure OS domain or an unsecure OS mode.

The ISP 304 is logically grouped with a GPU (e.g., APD 116). The ISP 304 is not directly connected to the data fabric bus (e.g., bus connecting the GPU cores to other peripherals, such as a memory controller and I/O hub). Instead, the ISP 304 lies behind shared PCIe infrastructure which exposes the ISP 304 to software as a PCIe sub-device of the GPU. The ISP 304 shares memory access infrastructure and hardware with the GPU, but its operation, processing, and functionality is separate and distinct from the GPU. The ISP 304 does not use the GPU shader or SIMD functionality. ISP 304 processes pixels of captured images using its own fixed-function hardware. The captured images (frames) are received by the ISP 304 via either a MIPI interface or a buffer residing in memory (e.g., memory 104), neither of which are directly dependent on GPU processing functionality. For example, the ISP 304 processes the frame data (e.g., data in input buffers) using internal hardware and provides the resulting processed frames to an output buffer without any involvement by the GPU. The processed frame data is then provided to a GPU (e.g., APD 116) to perform any additional processing (e.g., graphics processing, user interface UI design) on the images (frames).

The IPU 306 includes hardware circuitry IPU HW circuitry 320 and IPU secure FW 322 (e.g., in a secure domain separate from the OS) which is configured to accelerate machine learning neural network jobs, (e.g., image classification, object recognition, face recognition) and to make predictions or decisions for performing particular tasks (e.g., whether an image includes a certain object).

The IPU 306 is configured to perform object recognition (e.g., face recognition) on the processed images (e.g., video images) and identify one or more regions of interest as comprising one or more objects of interest.

For example, a neural network is trained, prior to runtime, to recognize one or more objects of interest through providing examples or references (e.g., previously captured images comprising the one or more objects) during a registration or training phase. The IPU 306 is configured to identify the one or more regions of interest as comprising the one or more objects of interest using the trained neural network. Alternatively, image data comprising the one or more stored objects of interest can be provided, during runtime, as inputs to the neural network and the IPU 306 then identifies the one or more regions of interest as comprising the one or more objects of interest.

The IPU is not logically grouped within the GPU, but is for example located on the same chip (e.g., part of the same accelerated processing unit (APU)) and is connected to data fabric bus.

The IPU 306 is configured to perform object and face recognition on the captured images (e.g., video images), processed by the ISP 304, using the objects of interest (e.g., nonviewable objects of interest such as faces of family members and/or viewable objects of interest) accessed from object of interest list portion of memory 310. The IPU 306 is configured to determine region of interest information (e.g., via a segmentation map or a bounding box) based on the output of the neural network and provide the region of interest information to the ISP 304.

Alternatively, the IPU 306 includes pixel processing capability and is also configured to modify the image based on the result of its own inference processing.

The IOMMU 308 includes hardware circuitry configured to map device visible virtual addresses to physical addresses. The IOMMU 308 is configured to receive captured and processed frames (e.g., modified privacy filtered frames or maintained non-filtered frames) and perform the address mapping for the frame data to be displayed.

As shown in the example in FIG. 3, the computing device 400 also includes fenced memory regions 324(a) and 324(b). The fenced memory regions 324(a) and 324(b) are, for example, trusted memory regions (e.g., regions of memory which are not accessible by some components to prevent images from being hacked from outside sources). The fenced memory regions 324(a) and 324(b) are used for hardware-to-hardware secure memory sharing. To facilitate privacy and security, while also being able to perform operations on the data, access to the fenced memory regions 324(a) and 324(b) by hardware (e.g., processor) is permitted based on an identifier which identifies the specific type of hardware (e.g., IPU 306, ISP 304, GPU, a CPU (e.g., x86 CPU) or other processor) requesting access to the fenced memory regions 324(a) and 324(b). For example, the ISP 304 and the IPU 306 shown in FIG. 3 are each identified by a corresponding identifier. Upon their identification, the ISP 304 (and its associated ISP Secure FW 318) and the IPU 306 (and its associated IPU Secure Firmware 322) are permitted access to the fenced memory regions 324(a) and 324(b). Other components of the computing device 300, such as the CPU (e.g., X86 CPU) which execute applications (e.g., application 312) and OS software (e.g., OS Camera Driver Software), including any malicious software, are not considered secure and are not permitted access to the secure fenced memory regions 324(a) and 324(b). For example, data stored in buffers used by the CPU are not part of the fenced memory regions 324(a) and 324(b). That is, fenced memory regions 324(a) and 324(b) are not accessible by the CPU because each transactions coming from the CPU, whether from benign or malicious software, identify the CPU using the same hardware identifier.

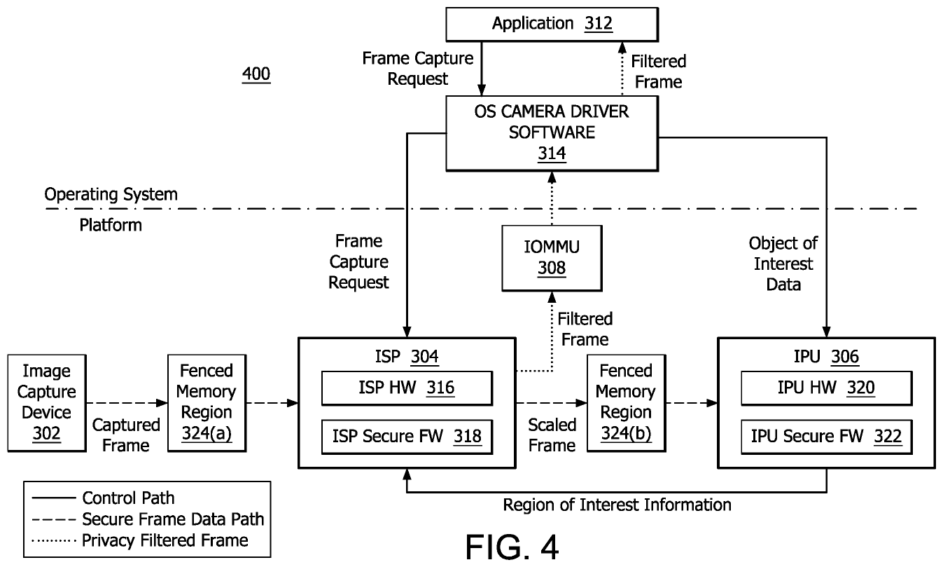

The example shown in FIG. 4, includes two separate fenced memory portions 324(a) and 324(b). Features of the present disclosure can also be implemented using a single fenced portion of memory (e.g., contiguous memory addresses). Features of the present disclosure can also be implemented without a fenced memory region.

FIG. 4 is a block diagram illustrating example components of a computing device 400 in which one or more features of the disclosure can be implemented, according to another example.

As shown in the example at FIG. 4, the computing device 400 does not include a secure object of interest list (e.g., in object of interest list portion of memory 310, shown in FIG. 3, which is not assessable to the OS). Rather, object of interest data, which includes stored nonviewable objects of interest (e.g., faces of individuals which are not to be viewed by others) and/or viewable objects of interest (e.g., faces of individuals permitted to be viewed by others), is accessed by the OS from a non-secured portion of memory and provided to the IPU 306 to determine the region of interest information.

However, as shown in FIG. 4, the ISP FW 318 and the IPU secure FW 322 are in the secure domain, separate from the OS. Accordingly, during runtime the captured and processed images (frames) are prevented from being accessed and tampered with (e.g., hacked) by outside sources.

The remaining components (e.g., IPU 306 and ISP 304) and functions of the components shown in FIG. 4 are the same or substantially similar as the components described with regard to FIG. 3. Accordingly, description of these components and functions is omitted as being superfluous.

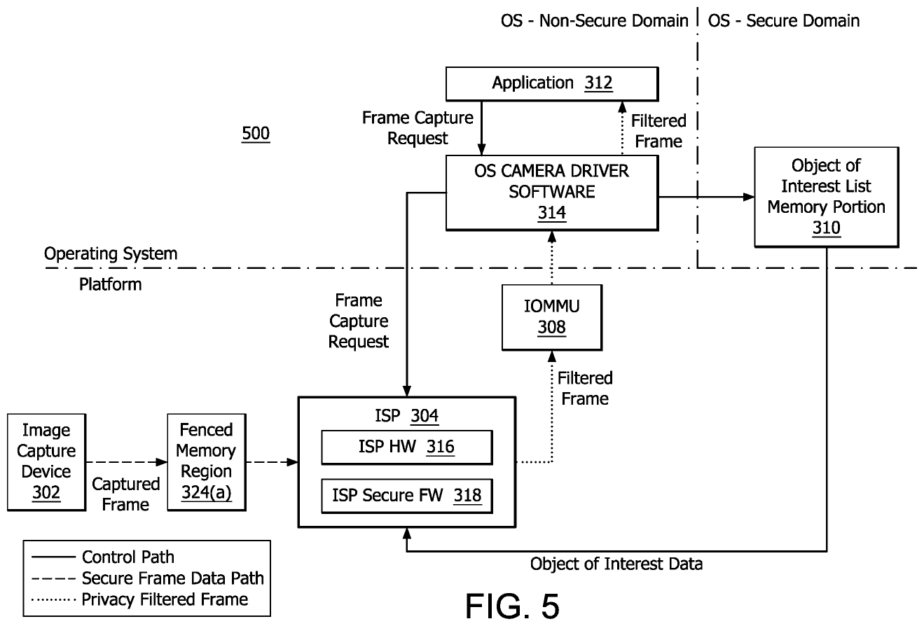

FIG. 5 is a block diagram illustrating example components of a computing device 500 in which one or more features of the disclosure can be implemented, according to another example.

In the example shown at FIG. 5, the ISP 304 is configured to perform object detection (e.g., face detection). Accordingly, computing device 500 does not include a separate processor (e.g., IPU 306 shown in FIGS. 3 and 4) to perform the object detection. Instead, the object of interest data (e.g., objects of interest in the object of interest list portion of memory 310) is provided to the ISP 304 to perform the object detection (e.g., face detection) based on the object of interest data. That is, the ISP 304 is configured to determine whether any regions of the images include one or more objects of interest from the object of interest list and modify (or maintain) the images based on the determination.

For example, on the condition that the object of interest data includes objects of interest from the object of interest list (e.g., nonviewable or viewable objects of interest). the ISP 304 is configured to determine one or more corresponding regions of the images which include the one or more objects of interest and modify the image (e.g., remove, obscure, blur the one or more objects of interest in the determined regions). The privacy filtered image (frame) is then provided to a GPU (e.g., APD 116 shown in FIG. 2) for additional processing and then to the OS via IOMMIU 308 for display. Alternatively, on the condition that the image does not include that the object of interest data does not include objects of interest from the object of interest list, the ISP 304 is configured to maintain the image (i.e., not modify the image) and the privacy filtered image (in this case, filtered but not modified based on object of interest data) is provided to a GPU (e.g., APD 116 shown in FIG. 2) for additional processing and then to the OS via IOMMIU 308 for display.

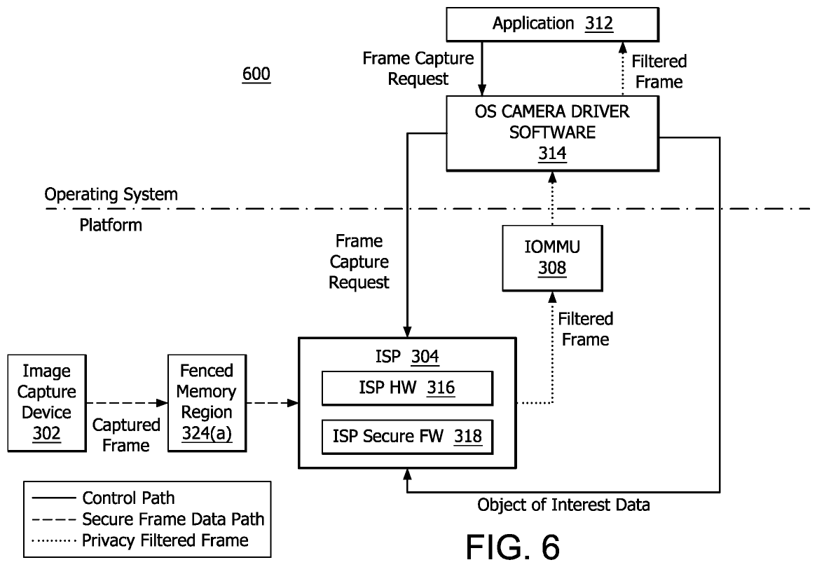

FIG. 6 is a block diagram illustrating example components of a computing device 600 in which one or more features of the disclosure can be implemented, according to another example. In the example shown at FIG. 6, the computing device 600 does not include a secure object of interest list (e.g., secure object of interest list portion of memory 310, shown in FIG. 3). Rather, object of interest data, which includes a stored nonviewable objects of interest (e.g., faces of individuals which are not to be viewed by others) and/or viewable objects of interest (e.g., faces of individuals permitted to be viewed by others), can be accessible by an untrusted or non-secure OS of the computing device 300.

In addition, the ISP 304 is configured to perform object detection (e.g., face detection). Accordingly, computing device 600 does not include a separate processor (e.g., IPU 306 shown in FIGS. 3 and 4) to perform the object detection. Instead, the object of interest data (e.g., objects of interest from a stored object of interest list) is provided to the ISP 304 to perform the object detection (e.g., face detection) based on the object of interest data. That is, as described above with regard to FIG. 5, the ISP 304 is configured to determine whether any regions of the images include one or more objects of interest from the object of interest list and modify (or maintain) the images based on the determination.

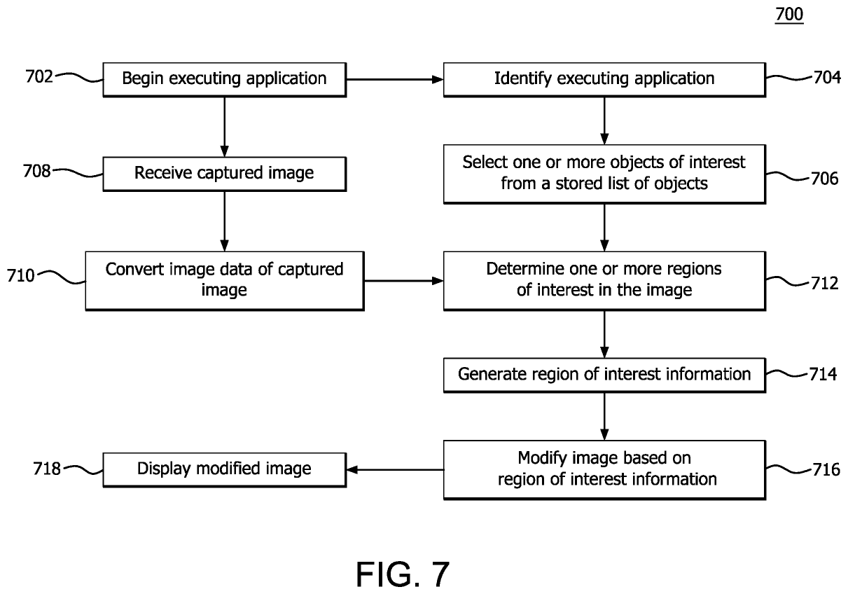

FIG. 7 is a flow diagram illustrating an example method 700 of filtering objects of interest of images captured at a computing device, according to features of the disclosure.

As shown in FIG. 7, an application begins executing at block 702. For example, the application begins executing (e.g., on processor 102) by issuing a frame capture request.

At block 704, the application is identified (e.g., by processor 102) as an application in which images captured at the computing device, are to be displayed and potentially viewed by others. For example, the application is identified as a particular video conferencing application. The application can be identified, for example, via an API (e.g., provided by driver 122).

When the application is identified as an application in which images captured at the computing device, are to be displayed and potentially viewed by others (e.g., a video conferencing application), one or more objects of interest are selected (e.g., using secure firmware 310 separate from the OS), at block 706, from the list of stored objects of interest (e.g., stored in secure object of interest portion of memory 310). The stored objects of interest include, for example, one or more nonviewable objects of interest (e.g., objects which are not to be clearly viewed for a particular video conferencing application, such as faces of family members of a user of a computing device). Additionally, or alternatively, the stored objects of interest can include a list of viewable objects of interest (e.g., face of the user). The object of interest list can be stored in a secure domain (e.g., in a portion of memory which is not assessable to the OS) or, alternatively, object of interest data is accessed by the OS from a non-secured portion of memory.

Captured image data is received at block 708. For example, an image is captured by image capture device 302 (e.g., a camera of the computing device 300) and the image data (e.g., MIPI image data or frame data) representing the captured image is received by ISP 304.

The captured image data (i.e., frame data) is then converted, at block 710, to data which can be more efficiently processed (e.g., by IPU 306) to determine whether the captured image includes one or more of the selected objects of interest. For example, RAW image data of the captured image is converted (e.g., by ISP 304) to the RGB domain or YUV domain and downscaled (e.g., to a lower resolution).

The converted image data is then processed (e.g., by IPU 306), at block 712, to determine one or more regions of interest which include the selected one or more of objects of interest. For example, both the converted image data representing the captured image and the image data representing each of the one or more of the selected objects of interest are provided as inputs to a trained neural network. The IPU 306 performs inference processing on the images using the neural network. Based on the results of the inference processing, the IPU 306 predicts (determines) whether the captured image includes one or more of the selected objects of interest and generates, at block 714, region of interest information identifying regions of the image which include the one or more objects of interest.

The image is then modified, at block 716, based on the region of interest information. For example, the region of interest information is provided to ISP 304. When the image includes one or more nonviewable objects of interest, the ISP 304 is configured to modify (e.g., remove, obscure or blur) the one or more nonviewable objects of interest (e.g., faces of family members) in the regions identified by the region of interest information. Additionally, or alternatively, nonviewable objects of interest can be prevented from being clearly viewed by cropping an image such that one or more viewable objects of interest (e.g., a face of a user) is shown in the image without showing the one or more nonviewable objects of interest. When the image does not include any objects of interest, the ISP 304 is configured to maintain the image (i.e., not modify the image).

Alternatively, the IPU 306 includes pixel processing capability and internal local inferencing functionality and is configured to modify the image based on the result of its own inference processing.

The modified (or maintained) image (e.g., privacy filtered frame) is then displayed, at block 718, on a display device (e.g., IO device 118) at each computing device participating in the video conferencing. For example, the privacy filtered frame is provided to IOMMU 308 which the privacy filtered frame and performs address mapping for the frame data. The data representing the privacy filtered frame is then displayed according to the instructions of the OS camera software

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of filtering objects of interest of images captured at a computing device, the method comprising:
for a captured image:
determining one or more regions of interest in the captured image based on one or more objects of interest; and
modifying the captured image for display based on the determined one or more regions of interest,
wherein the captured image is displayed without the one or more objects of interest being viewable.

2. The method of claim 1, further comprising:
identifying an application executing on the computing device as a video conferencing application:
in response to the identification of the application executing on the computing device, selecting the one or more objects of interest from a stored list of objects of interest; and
determining the one or more regions of interest in the captured image based on the selected one or more objects of interest.

3. The method of claim 2, wherein the stored list of objects of interest are stored in a secure portion of memory which is not accessible by an operating system of the computing device.

4. The method of claim 2, wherein the stored list of objects of interest comprise one or more nonviewable objects of interest, and
the captured image is modified to prevent the one or more nonviewable objects of interest, in the stored list of objects of interest, from being viewable in the captured image.

5. The method of claim 4, wherein modifying the captured image to prevent the one or more nonviewable objects of interest from being viewable comprises blurring the one or more nonviewable objects of interest, blacking out the one or more nonviewable objects of interest, or distorting the one or more nonviewable objects of interest.

6. The method of claim 4, wherein the stored list of objects of interest further comprise one or more viewable objects of interest, and
the captured image is modified to prevent the one or more nonviewable objects of interest from being viewable in the captured image by cropping the captured image to include the one or more viewable objects of interest without the one or more nonviewable objects of interest.

7. The method of claim 1, further comprising determining the one or more regions of interest by performing inference processing, using a neural network, on the captured image.

8. The method of claim 7, further comprising:
providing, as inputs to the neural network, image data representing the captured image and image data representing the one or more objects of interest; and
identifying the one or more regions of interest as comprising the one or more objects of interest.

9. The method of claim 1, further comprising identifying the one or more regions of interest as comprising the one or more objects of interest using a neural network, trained prior to runtime, to recognize the one or more objects of interest.

10. A computing device for filtering objects of interest of images comprising:
an image capturing device;
memory configured to store objects of interest; and
a processor configured to, for an image captured by the image capturing device:
determine one or more regions of interest in the image based on one or more objects of interest; and
modify the image based on the determined one or more regions of interest,
wherein the image is displayed without the one or more objects of interest being viewable.

11. The computing device of claim 10, wherein the processor is configured to:
identify an application executing on the computing device as a video conferencing application:
select, from a stored list of objects of interest, the one or more objects of interest, in response to the application executing on the computing device being identified; and
determine the one or more regions of interest in the captured image based on the selected one or more objects of interest.

12. The computing device of claim 10, wherein the objects of interest are stored in a secure portion of the memory which is not accessible by a non-secure operating system of the computing device.

13. The computing device of claim 10, wherein the objects of interest comprise one or more nonviewable objects of interest, and
the processor is configured to:
select the one or more nonviewable objects of interest; and
modify the image by preventing the one or more nonviewable objects of interest from being viewable in the image.

14. The computing device of claim 13, wherein the objects of interest further comprise one or more viewable objects of interest, and
the processor is configured to modify the image and prevent the one or more nonviewable objects of interest from being viewable in the image by cropping the image to include the one or more viewable objects of interest without the one or more nonviewable objects of interest.

15. The computing device of claim 10, wherein the processor is configured to determine the one or more regions of interest by performing inference processing, using a neural network, on the image.

16. The computing device of claim 15, wherein the processor is configured:
input, to the neural network, image data representing the image and image data representing the one or more objects of interest; and
identify the one or more regions of interest as comprising the one or more objects of interest according to a result of the inference processing.

17. The computing device of claim 10, further comprising a display, wherein the modified image is displayed at the display.

18. A computing device for filtering objects of interest of images comprising:
an image capturing device;
memory configured to store objects of interest; and
a first processor configured to, for an image captured by the image capturing device, determine one or more regions of interest to be modified in an image captured by the image capturing device based on the one or more objects of interest; and
a second processor configured to, for the image captured by the image capturing device:
convert the image for processing by the first processor; and
modify the image based on the one or more regions of interest determined by the first processor,
wherein the image is displayed without the one or more objects of interest being viewable.

19. The computing device of claim 18, wherein,
the first processor is an inference processing unit configured to determine the one or more regions of interest by performing inference processing on the image using a neural network, and
the second processor is an image signal processor, in a secure domain separate from a domain comprising an operating system of the computing device.

20. The computing device of claim 18, wherein portions of the memory accessed by the first processor and the second processor are secure portions of memory which are not accessible by a non-secure operating system of the computing device.
